(19) United States
(12) Patent Application Publication
(10) Pub. No.: US 2012/0262018 A1
(43) Pub. Date: Oct. 18, 2012

(54) Self generating electrical system

(76) Inventor: Hardial Singh Thiara, Orland, CA (US)

(21) Appl. No.: 13/066,530

(22) Filed: Apr. 18, 2011

(51) Int. Cl. H02K 47/14; H02K 53/00

(52) U.S. Cl. 310/113; 74/DIG. 9

(57) ABSTRACT

A self generating electrical system includes in one embodiment a 96 volt DC power source made up of eight 12 volt rechargeable batteries connected in series, a first 28 HP DC motor and a controller for receiving the output from the DC power source and supplying the output so received to the first DC motor in a controlled manner. A gear mechanism driven by the first DC motor has its output connected to a set of four 24 volt alternators used to recharge the eight 12 volt batteries and also adapted to be connected to an external load. In another embodiment of the invention the gear mechanism is eliminated and the output of the DC motor is applied directly to the set of four alternators used to recharge the batteries and also through a gear box to a 7800 Watts AC generator which may be connected to any one of a number of external loads. In a third embodiment of the invention the system includes first and second DC motors. The fourth embodiment herein omits the gear system, thus permitting either forward and backward motion of the motor which can be translated to a vehicle to go forward or backward.

### BACKGROUND OF THE INVENTION

The present invention relates to a self generating electrical system which includes a first DC motor for generating electrical energy and a plurality of batteries for supplying power to the DC motor and wherein a portion of the energy generated by the first DC motor is used to provide power to recharge the plurality of batteries. In one embodiment of the invention, the output of the first DC motor is fed into a gear mechanism whose output may be connected to an external load. In another embodiment of the invention, the output of the DC motor is fed into an AC generator through a gear box and in a third embodiment of the invention, the output of the first DC motor is fed into a gear mechanism whose output is fed into a second DC motor which is arranged to operate as an AC generator.

### DESCRIPTION OF PRIOR ART

In U.S. Pat. No. 7,095,126 to J. McQueen there is disclosed a system for generating electrical power in which an external power source such as a battery is used to initially supply power to start an alternator and an electric motor. Once the system has started it is not necessary for the battery to supply power to the system. The battery can then be disconnected. The alternator and electric motor work in combination to generate electrical power. The alternator supplies this electrical power to two inverters. One inverter outputs part of its power to a lamp and part back to the electric motor. This power is used to power the electric motor. The second inverter supplies power to the specific load devices that are connected to the system.

In U.S. Pat. No. 5,036,267 to Markunas et al there is disclosed a system for starting an aircraft turbine from a low voltage power supply by energizing a generator coupled to said turbine to operate as a motor during starting, comprising in combination: an inverter having a direct current input coupled to said low voltage battery and an alternating current output; an auto-transformer having a starting mode input tap and a starting mode output tap, said auto-transformer coupling a stepped up voltage between said input tap and output tap; means for coupling said output tap to said generator; control means for coupling said inverter output to said generator initially during starting and thereafter coupling said inverter output to said transformer input tap; and means for controlling the input current to said generator to maintain the battery terminal voltage during starting at a predetermined level.

In U.S. Pat. No. 6,516,922 to Shadkin et al issued in 2003 there is disclosed an emergency descent system for elevators using gravitational forces to control the descent of an elevator cab in the event of a loss of power from an outside power source, the system comprising: counterweight assembly including a counterweight weighing less than the minimum weight of the elevator cab; generating unit operatively coupled to a drive member and electrically coupled to a load bank; cable having a first end and second end, the cable operatively coupled to the drive member between the first end and second end, the first end coupled to the counter weight assembly and the second end coupled to the elevator cab such that the weight differential between the counterweight assembly and the elevator cab causes the drive member to rotate, causing the generating unit to produce a first generator torque and a corresponding first current; and an elevator controller having a secondary power source to supply power to the elevator controller, the elevator controller electrically coupled to an outside power source, the secondary power source, the generating unit, and the load bank.

### SUMMARY OF THE INVENTION

It is an object of the present invention to provide an energy source that generates more energy than the energy source requires in order to operate.

It is another object of the present invention to provide a system that uses the excess energy produced to power external devices.

It is still another object of the present invention to provide an energy source for supplying power to various devices without the reliance on an external energy source.

It is yet still another object of the present invention to provide a new and novel energy source.

It is further object of the present invention to provide an energy source that can be initially started as desired and can produce energy until terminated as desired.

It is still a further object of this invention to provide an electrical system that is self generating.

It is yet still a further object of this invention to provide a self generating electrical system which includes a new and novel gear mechanism.

According to a first embodiment, in this invention there is provided a self generating electrical system which in one embodiment comprises a power supply for producing electrical energy, the power supply comprising a plurality of batteries, a first DC motor for converting electrical energy to mechanical energy, a controller electrically coupled between the battery power supply and the first DC motor for receiving electrical energy from the battery power supply and supplying electrical energy to said first DC motor in a controlled manner, a plurality of DC alternators electrically coupled to the power supply for continuously recharging the plurality of batteries in the power supply and a gear mechanism mechanically coupled to the first DC motor for selectively changing the amount mechanical energy outputted by the DC motor. The output of the gear mechanism is adapted to be connected to an external load and is also used to drive the plurality of DC alternators. By way of examples only, the external load may be an automotive vehicle, a water pump and a turbine system or an air conditioner.

In a second embodiment of the invention, the self generating electrical system comprises a power supply for producing electrical energy, the power supply comprising a plurality of batteries, a first DC motor for converting electrical energy to mechanical energy, a controller electrically coupled between the power supply and the DC motor for receiving electrical energy from the power supply and supplying electrical energy to said first DC motor in a controlled manner. A plurality of DC alternators are electrically coupled to the power supply and mechanically coupled to the output of the DC motor for continuously recharging the plurality of batteries in the power supply, An AC generator is mechanically coupled to the output of the DC motor through a gear box and is adapted to supply AC power to an external load. By way of examples only, the external load may be a house, a commercial complex or a piece of industrial machinery.

In a third embodiment of the invention, the self generating electrical system is similar to the first embodiment of the invention but includes a second DC motor coupled to the output of the gear mechanism for converting the mechanical energy outputted by the gear mechanism into electrical energy.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like references numerals represent like parts:

FIG. 1 is a block diagram of a self generating electrical system according to one embodiment of the invention;

FIG. 1A is a detailed view of block 13 in FIG. 1;

FIG. 2 is a front perspective view of the gear mechanism shown in FIG. 1;

FIG. 3 is a front view of the gear mechanism shown in FIG. 2 attached to a high speed drive shaft. Also shown are the alternators in FIG. 1;

FIG. 4 is a side view partly exploded of the gear mechanism shown in FIG. 3;

FIG. 5 is a perspective view of the various parts in the gear mechanism shown in FIG. 2;

FIG. 5A is a front view of the gear mechanism shown in FIG. 2 with the cover and other parts removed;

FIG. 5B is a detailed view of the gear mechanism in FIG. 2;

FIG. 5C is a perspective view of the back cover, the high speed drive shaft, the low speed drive shaft and the low speed sprocket roller in the gear mechanism in FIG. 3.

FIG. 6 is a perspective taken from the rear of the gear mechanism in FIG. 2 coupled to the axle of a truck;

FIG. 7 is a perspective taken from the front of the gear mechanism in FIG. 2 coupled to the front wheels of the truck in FIG. 6;

FIG. 8 is a block diagram of a second embodiment of a self generating electrical system of the invention;

FIG. 8A is a simplified perspective view of the DC motor, the alternators, the belts and pulleys, the gear box and the AC generator in the system in FIG. 8;

FIG. 8B is an exploded view of the AC generator shown in FIG. 8;

FIG. 8C is an exploded view of the gear box shown in FIG. 8;

FIG. 9 is a perspective view similar to FIG. 8A but with the alternator arranged differently;

FIG. 10 is a pictorial view of the controller box containing the controller and other components and which may be part of the system in FIG. 1 or in FIG. 8;

FIG. 11 is a block diagram of an apparatus using the system shown in FIG. 1;

FIG. 12 is a block diagram of an apparatus using the system shown in FIG. 8;

FIG. 13 is a simplified pictorial view showing a portion of the system in FIG. 1 connected to a water pump turbine system;

FIG. 14 is a block diagram of a third embodiment of a self generating electrical system of this invention;

FIG. 15 is a perspective view taken from the side of a portion of the embodiment shown in FIG. 14; and

FIG. 16 is a perspective view taken from the rear of the portion of the embodiment shown in FIG. 15.

FIG. 17 is a pictorial view related to FIG. 10 but which relates to a fourth embodiment, wherein the gearing system is omitted.

FIG. 18 is a circuit diagram for the reversing contactor wiring designated in FIG. 17.

FIG. 19 is a top plan view of the reversing contactor set.

FIG. 20 is a photo-diagram of the installation of the 4^{th} embodiment of this apparatus disposed in a 1992 GMC ½ ton pickup truck.

### DETAILED DESCRIPTION OF THE PREFERRED EMBODIMENT

The present invention is directed to a self generating electrical system that produces more power than it takes to operate the system and wherein the excess power generated may be used in any of a variety of applications, such as to provide electricity to a house or electricity to industrial machinery or to run a vehicle.

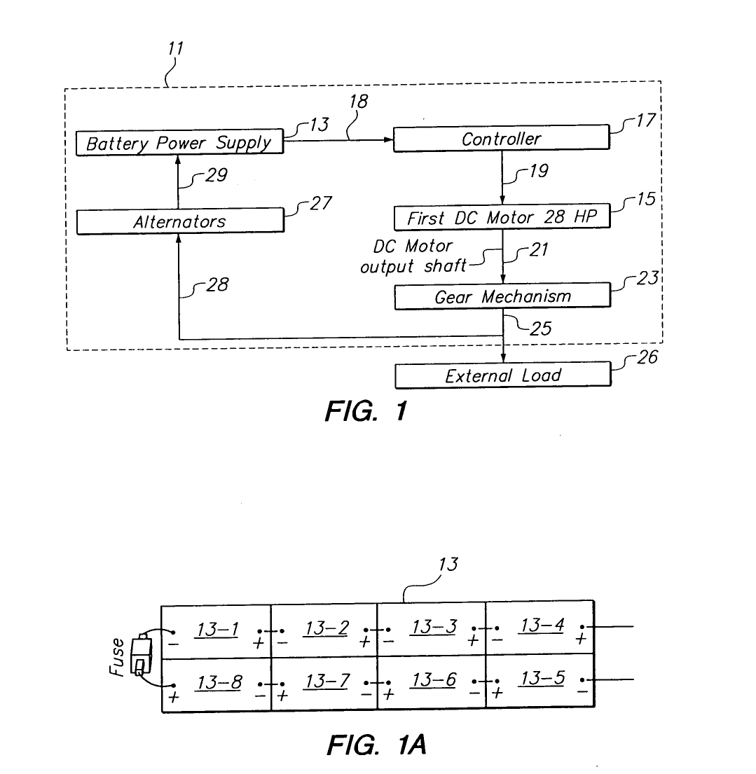

Referring now to the drawings, and first to FIG. 1, there is shown one embodiment of a self generating electrical system according to this invention, the system being identified by reference numeral 11. FIG. 1A is present for the ease and convenience of the reader to understand details shown in FIG. 1.

Self generating electrical system 11, includes a battery power supply 13. Battery power supply 13 comprises eight 12 V batteries designated 13-1 to 13-8, all of which are connected in series to produce 96 volts DC of electrical energy (see FIG. 1A). The batteries may be LS3100 Dual Pro Deep Cycle batteries. As is known, when batteries are connected in series, the output voltage is the sum of the volts of the individual batteries.

Self generating electrical system 11 further include a first 28 HP, 72-120 volt DC motor 15, and a 96 to 144 volt, 500 amp controller 17. The purpose of first DC motor 15 is to convert electrical energy to mechanical energy and the purpose of controller 17 is to govern in some predetermined manner the performance of DC motor 15. DC motor 15 includes an output shaft 21.

A typical controller may include a manual or automatic means for starting and stopping the motor, selecting forward or reverse rotation, selecting and regulating the speed, regulating or limiting the torque and protecting against overloads and faults.

DC motor 15 may be an Advanced brand DC#FBI-4001 A 28 HP 72-120 volt motor and the controller 17 may be a Curtip #1231C-8501 96-144 volt, 500 A motor controller or equal.

As can be seen, the output of power supply 13 is electrically connected by a line 18 to controller 17 and the output of controller 17 is electrically connected by a line 19 to DC motor 15.

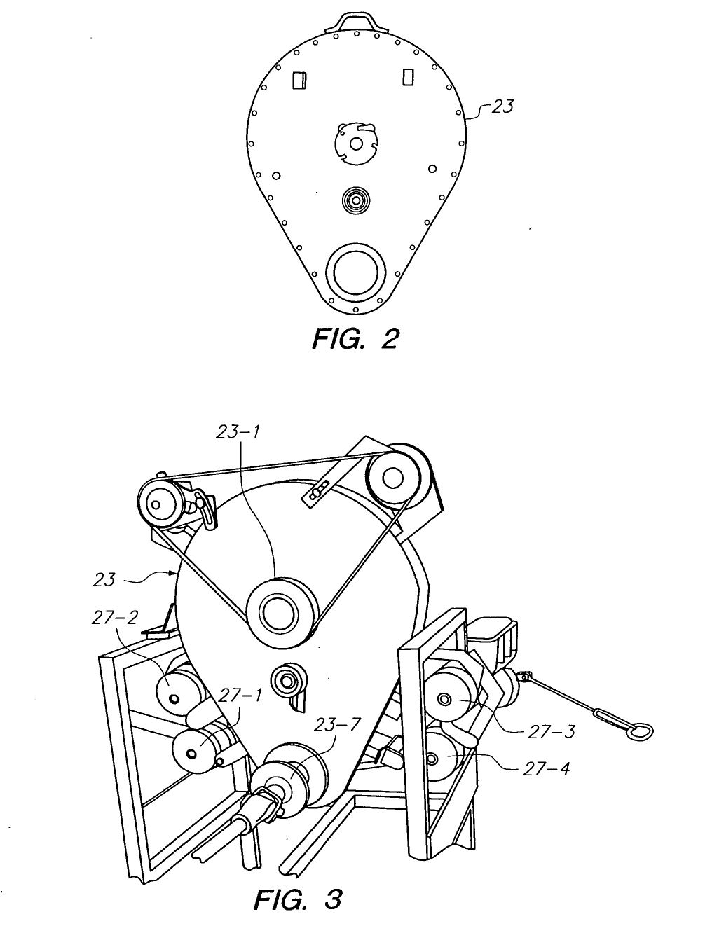

The output shaft 21 of DC motor 15 is mechanically connected to a gear mechanism 23. The purpose of gear mechanism 23 is to change the rotational speed of output shaft 21 of DC motor 15 to another speed as desired for a particular application. See FIGS. 2 & 3.

The output shaft 25 of gear mechanism 23, may be connected to an external load 26 and is also connected by pulleys and belts 28 to a set of alternators 27. The set of alternators 27, as seen in FIG. 3, consists of four 24 volt, 70 amp DC alternators 27-1, 27-2, 27-3 and 27-4.

As is known, an alternator is an electro-mechanical device that converts mechanical energy to electrical energy. The electrical energy output of an alternator is usually AC. However, by using a set of rectifiers (not shown), as with the alternators in the present invention, the AC output of alternators 27 is converted to a DC output. The four alternators, 27-1 through 27-4, taken together produce 96 volts DC at 280 amps.

The output of the set of alternators 27 is electrically fed through line 29 into power supply 13 with each alternator 27-1 to 27-4 being used to recharge two batteries 13-1 to 13-8 in power supply 13.

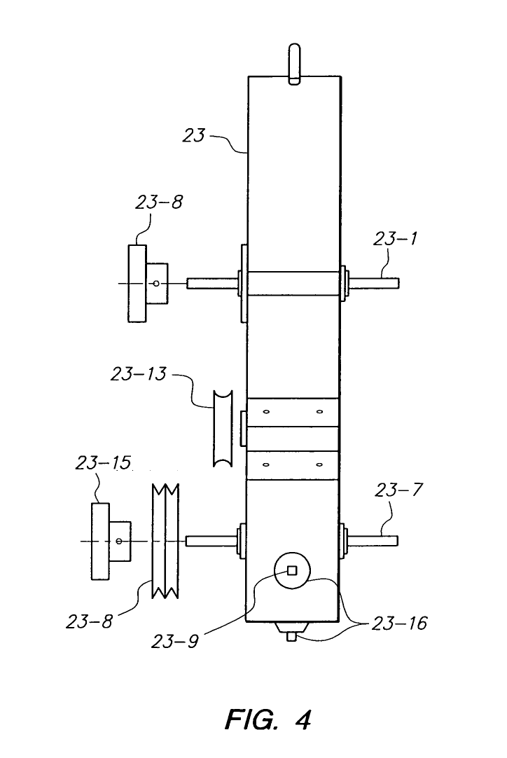

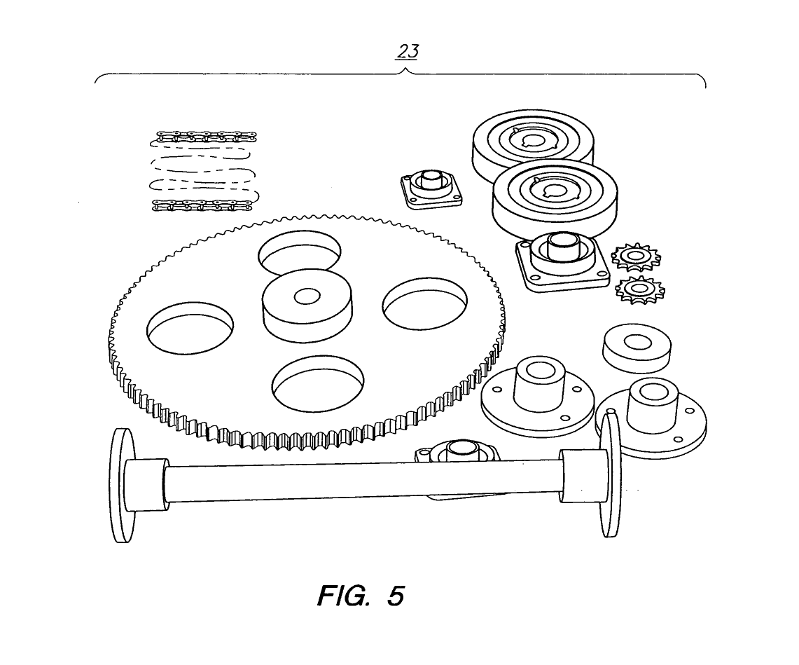

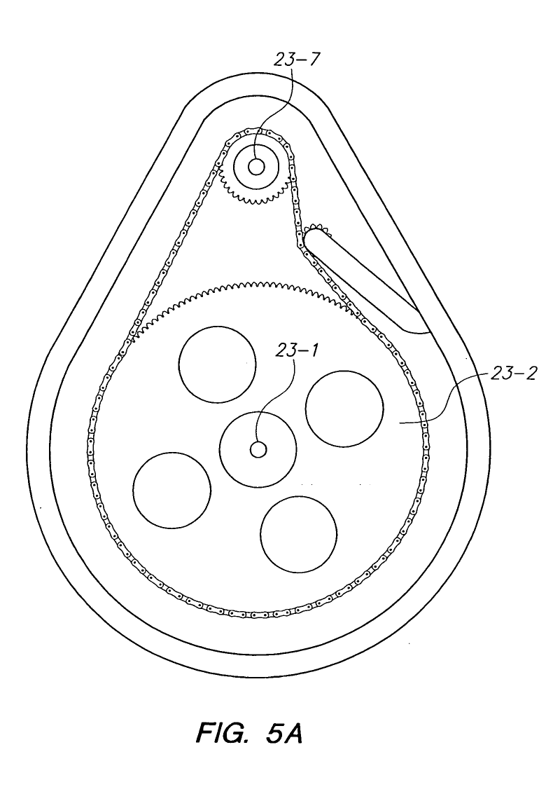

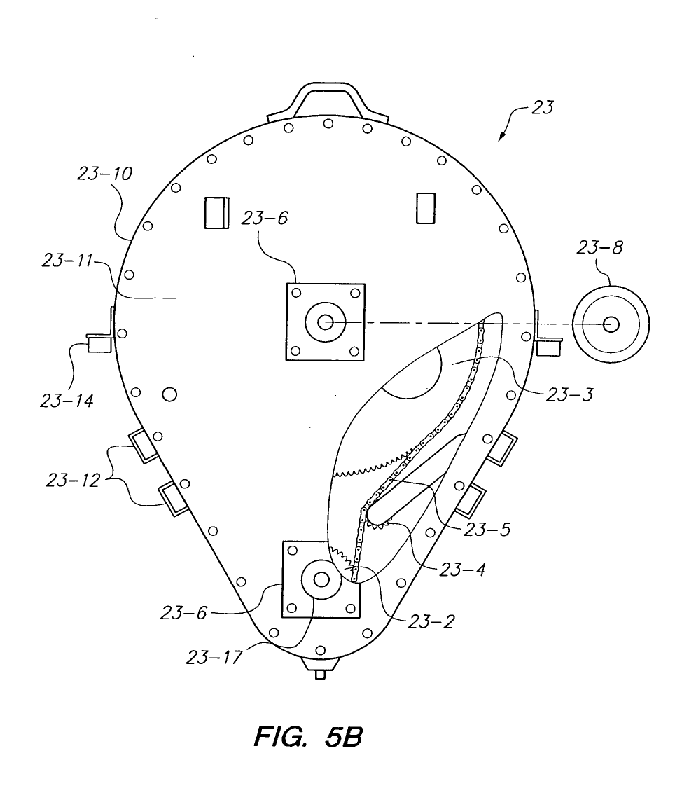

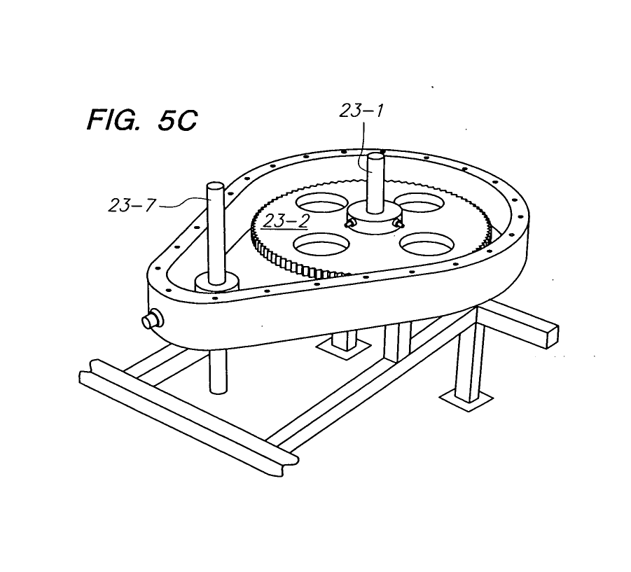

Gear mechanism 23, as seen in FIGS. 4, 5, 5A and 5B, includes a low speed drive shaft 23-1, a D50B22 teeth sprocket roller 23-2, a D50B112 teeth sprocket roller 23-3, a D50BB13 teeth G & G idler sprocket and adjusting arm 23-4, a 50-2 hit chain double 23-5, a UCF 208-24G5FyH 1½″ NDSS 4 bolt flange unit 23-6, a high speed drive shaft 23-7, a V belt sheaves 23-8, gears oil 80-90 23-9, outside gear case 23-10, gear case side cover 23-11, 4 alternator mounts 23-2, 2 belt idlers 23-13, 4 rubber mounts 23-4, 1½″ drive flanges 23-15, 2, ¾″ pipe plugs 23-16, and 2, 1½″ oil seals 23-17.

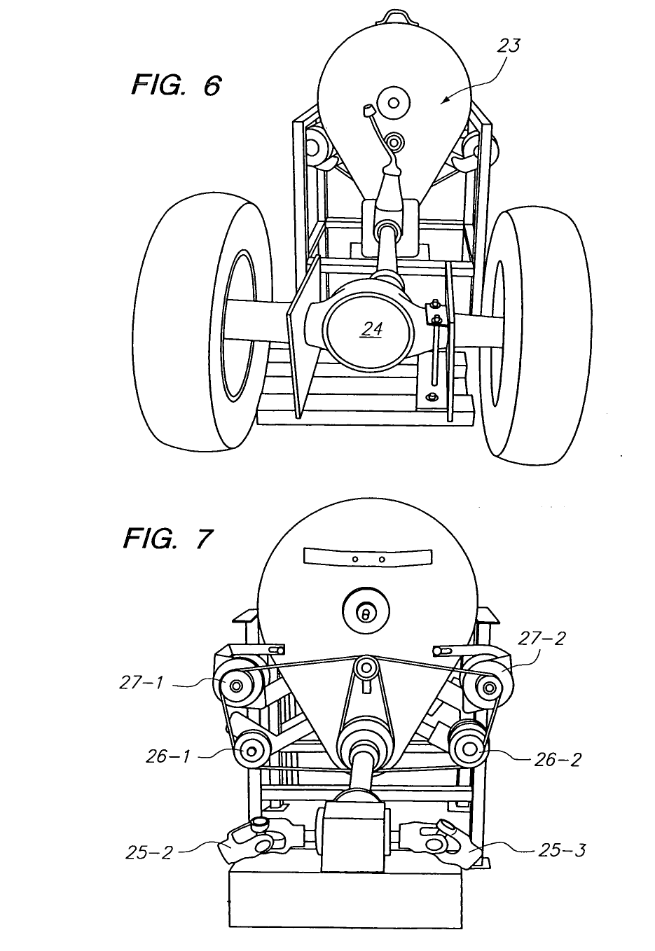

Gear mechanism 23 may be attached to the differential 24 of a vehicle as shown in FIG. 6 or to the front wheels connections 25-2 and 25-3 as shown in FIG. 7.

As can also be seen in FIG. 7, the external load 26 can include a power steering unit 26-1 and an air conditioner 26-2. Also shown in FIG. 7 are alternators 27-1 and 27-4 shown in FIG. 3. The ability to operate an air conditioner in remote locations is beneficial for use in locations where electrical power may not be available.

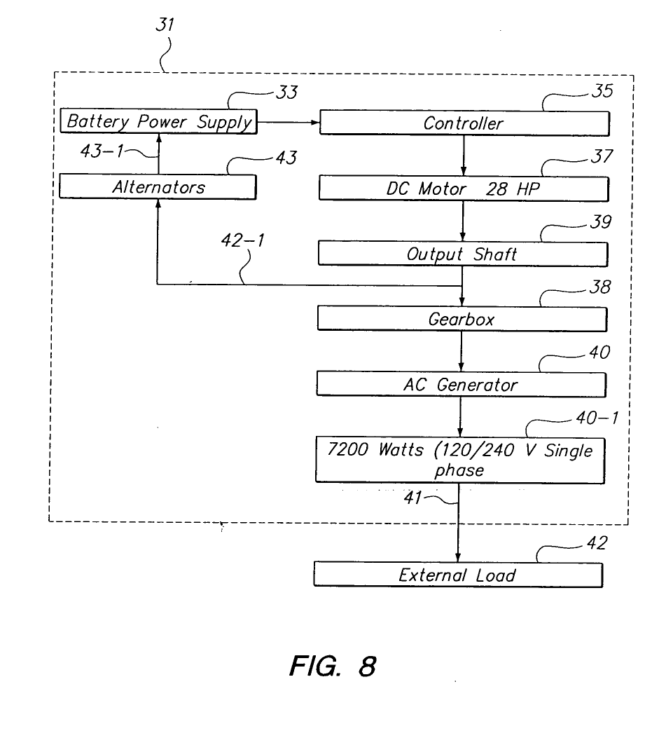

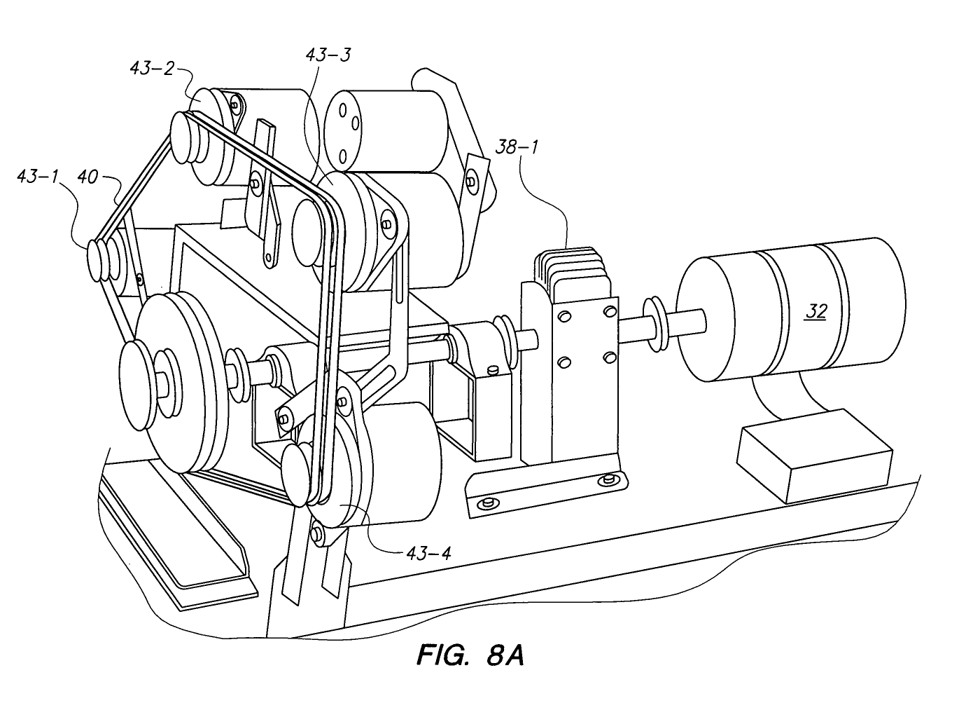

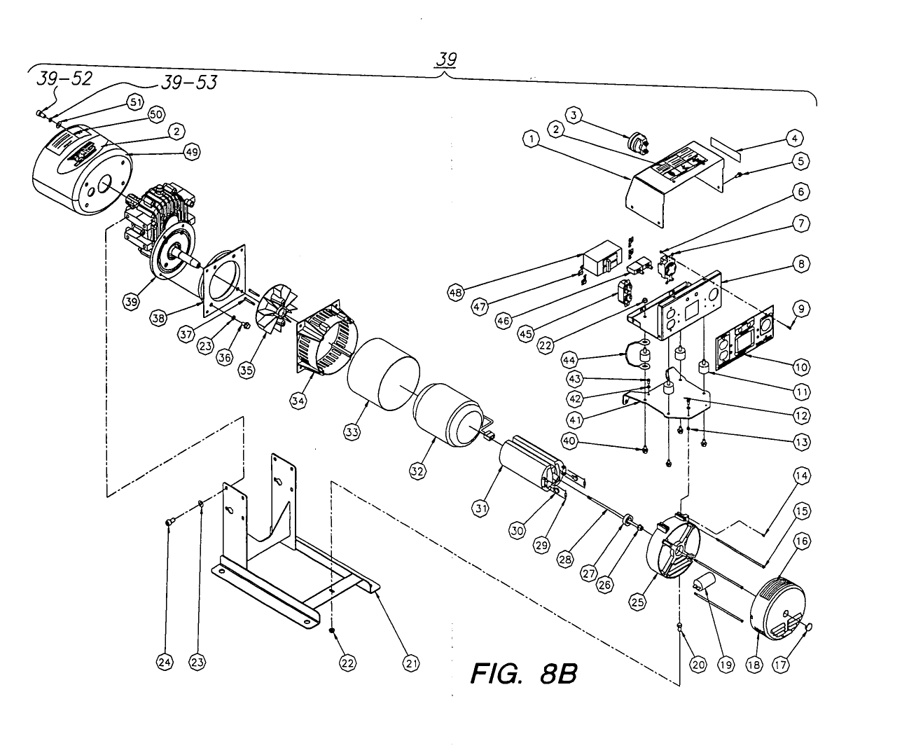

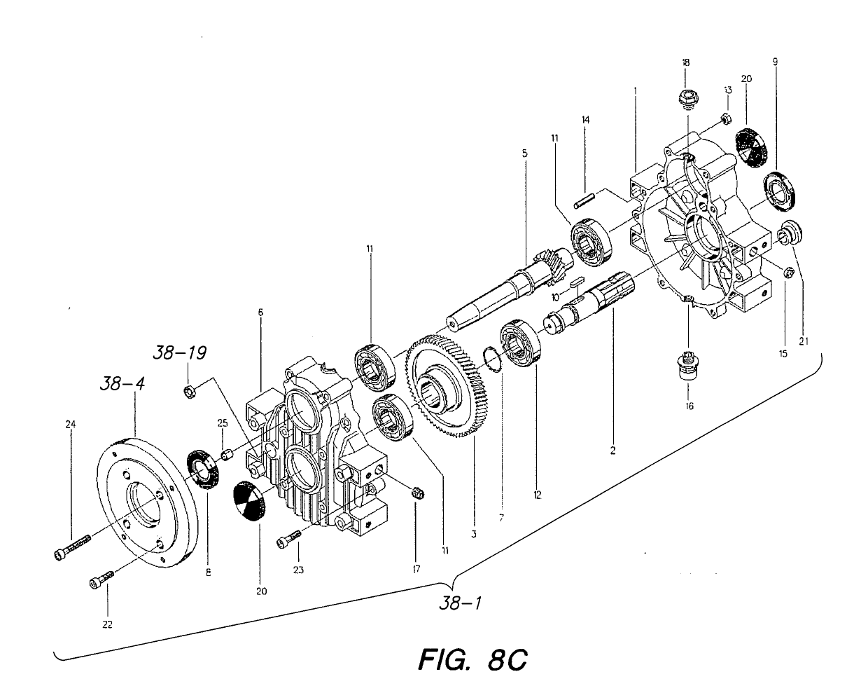

Referring now to FIG. 8, there is shown a block diagram of another embodiment of a self generating electrical system according to this invention, the embodiment being identified by reference numeral 31. FIGS. 8A,8B and 8C are added for ease of the reader in understanding various aspects of this embodiment.

Self generating electrical system 31 includes a battery power supply 33 structurally and functionally identical to battery power supply 13, a controller 35 structurally and functionally identical to controller 17 and a first DC motor 37 structurally identical to DC motor 15. However, in self generating electrical system 31, gear mechanism 23 as shown in system 11 is eliminated and replaced by a gear box 38. The output shaft 39 of DC motor 37 is mechanically coupled through gear box 38 to a 7800 watt AC generator 40 connected to an outlet box 40-1 which is adapted to be connected by a line 41 to an external load 42. Also, output shaft 39 is mechanically coupled by belts and pulleys 42-1 to a set of four alternators 43, labeled 43-1 through 43-4 in FIG. 8A, which are structurally identical to set of alternators 27. The DC output of alternators 43 is connected by a line 43-1 to power supply 33 in order to recharge the batteries contained therein in the same manner as the alternators 27 in system 11 are used to recharge the batteries in power supply 13 in system 11.

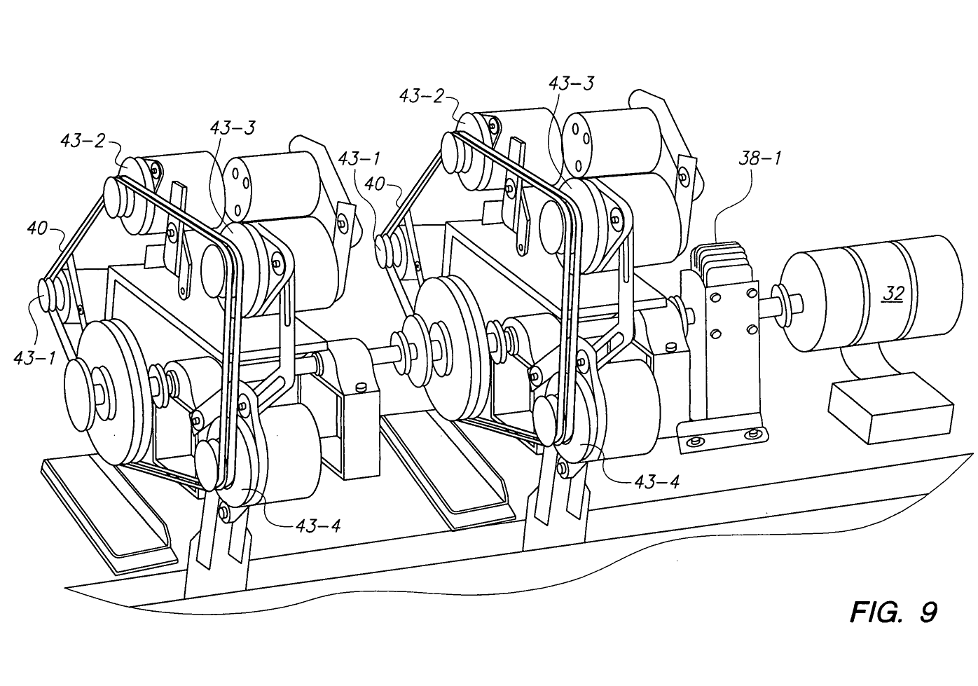

Referring now to FIG. 9, there is shown a simplified perspective view of a system shown in FIG. 8, but with the alternators arranged in pairs rather than all in a single loop. As can be seen, the system 45 includes a 28 DC HP motor 37, whose output shaft 38 is mechanically coupled by belts and pulleys 40 to alternators 41 and also to AC generator 39.

Referring now to FIG. 8B there is shown an exploded view of AC generator 39 shown in FIG. 8. As can be seen, AC generator 39 includes a control box top 39-1, a North Star Decal 39-2, a voltmeter 39-3, a warning decal 39-4, a ¼-20×5″ serrated flange bolt 39-5, a #8-32 Kaps nut 39-6, 120/240V, 30 A locking device receptacle 39-7, a control box 39-8, a #8-32 button head cap screw 39-9, a control panel 39-10, an isolation mount 39-11, a M5-0.8×14 mm pan Phillips screw 39-12, a M5-0.8 hex nut 39-13, a grounding screw 39-14, a bracket securing stud 39-15, a warning decal 39-16, an end cover plug 39-17, an end cover 39-18, a capacitor 39-19, a 5/16-18×1″ Hex head cap screw 39-20, a base 39-21, a 5/16-18×1″ serrated flange nut 39-22, a M10 rib washer 39-23, a M10-1.5×20 mm socket head cap screw 39-24, a non drive end bracket 39-25, a flange nut 39-26, a bearing 39-27, a rotor securing stud 39-28, a diode 39-29, a varister 39-30, a rotor 39-31, a stator 39-32, an enclosing band 39-33, a drive end bracket 39-34, a fan 39-35, a ⅜-16×0.75″ serrated flange bolt 39-36, a fan bolt 39-37, a mount plate 39-38, a gearbox 39-39, a 5/16-18×0.5″ serrated flange bolt 39-40, a control box mount plate 39-41, a #10 split lock washer 39-42, a #10-32×0.5″ pan Phillips screw, type F 39-43, a ground wire 39-44, a 120V, 20 A duplex receptacle 39-45, a circuit breaker, 125V-20 A 39-46, a circuit breaker mounting clip 39-47, a thermal magnetic breaker, 125/250V-30 A 39-48, a implement shield 39-49, a warning decal 39-50, a M10 flat washer 39-51, a M10-1.5×16 mm Hex head cap screw 39-52.

Referring now to FIG. 8C, there is shown an exploded view of gear box 38 in FIG. 8. As can be seen, gear box 38 includes a housing 38-1, a shaft 38-2, a gear 38-3, a flange 38-4, a shaft 38-5, a housing 38-6, a circlip 38-7, an oil seal, 25×52×10 mm 38-8, an oil seal 35×52×10 mm 38-9, a key, 10×8×25 mm 38-10, a bearing 38-11, a bearing 38-12, a nut, M8 38-13, a pin, 8×20 mm 38-14, a cap 38-15, a breather plug, ⅜″ 38-16, an oil plug, ⅜″ 38-17, a drain plug, ⅜″ 38-18, a cap 38-19, a cap 38-20, a sight glass 38-21, a screw, M8×20 mm 38-22, a screw, M8×40 mm 38-23, a screw, M8×110 mm 38-24 and a sleeve 38-25.

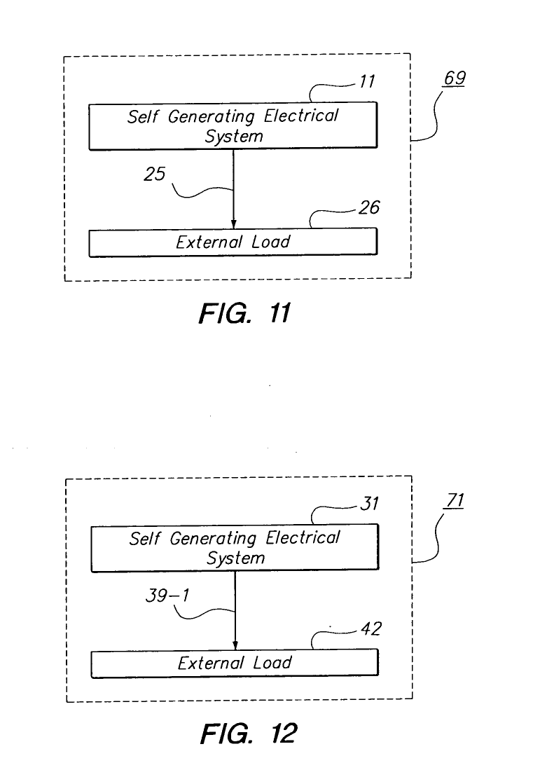

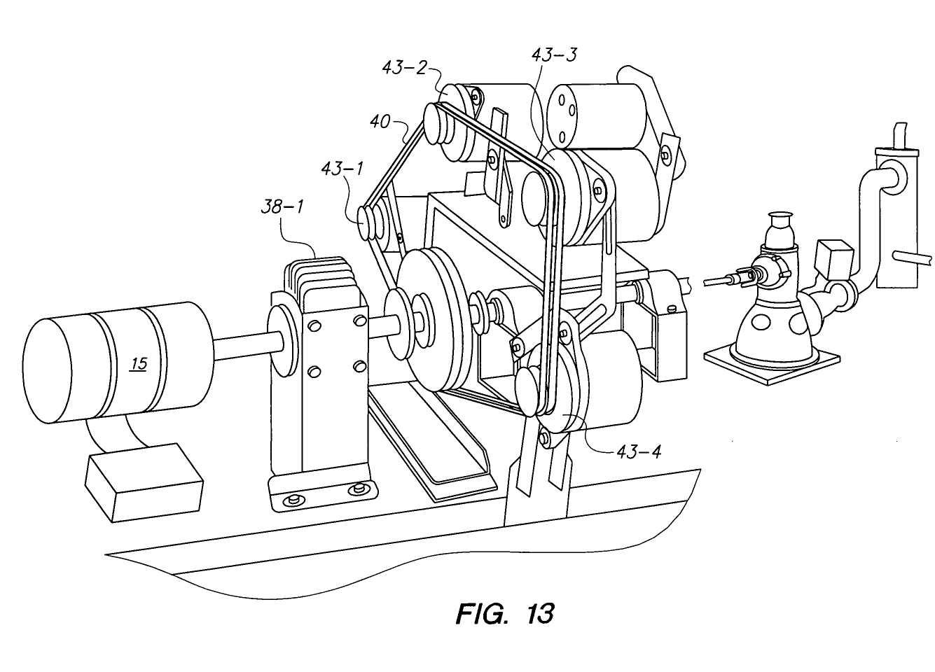

FIG. 11 shows an apparatus 69 made up of self generating electrical system 11 coupled to an external load 26 and FIG. 12 shows an apparatus 71 made up of self generating electrical system 31 coupled to an external load 42. External load 26 may be, for example, an automotive vehicle or a water pump and turbine system as shown in FIG. 13 or a compressor in a car air conditioner. External load 42 may be a house, a commercial complex or a piece of industrial machinery. FIG. 12 also depicts the system's operation but in block diagram format.

It should be noted that a self generating system according to this invention could be constructed which includes a larger or smaller sized DC motor than motor 15/37 and having a correspondingly larger or smaller number of batteries in the power supply which would be recharged by a correspondingly larger or smaller number of alternators. As an example, a system could be constructed similar to system 11, but different in that the DC motor would be a 48 volt motor instead of 72-120 volts, the battery power supply would output 48 volts instead of 96 volts and there would be two 24 volt alternators instead of four 24 volt alternators.

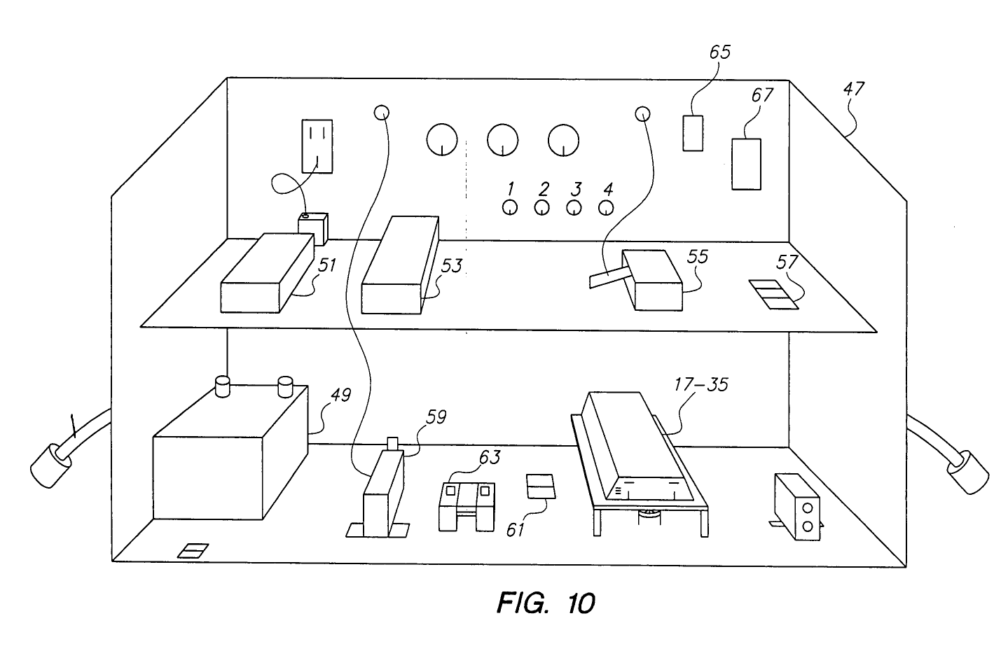

Controller 17/35 may be mounted in a box 47 as shown in FIG. 10. Additional components which may be included in box 47 are a 12 volt battery 49, a DC-DC converter 51, a 96 to 120 VAC onboard charger 53, a throttle pot box 55, a safety fuse 57, a circuit breaker 59, grounds 61, a shunt 63, an on-off switch 65 and an interlock relay 67.

Also, gear box 38 could be used in place of gear mechanism 23 in the FIG. 1 embodiment, if desired. The motor connector 90 can be in the form of a conventional 3 prong electrical plug.

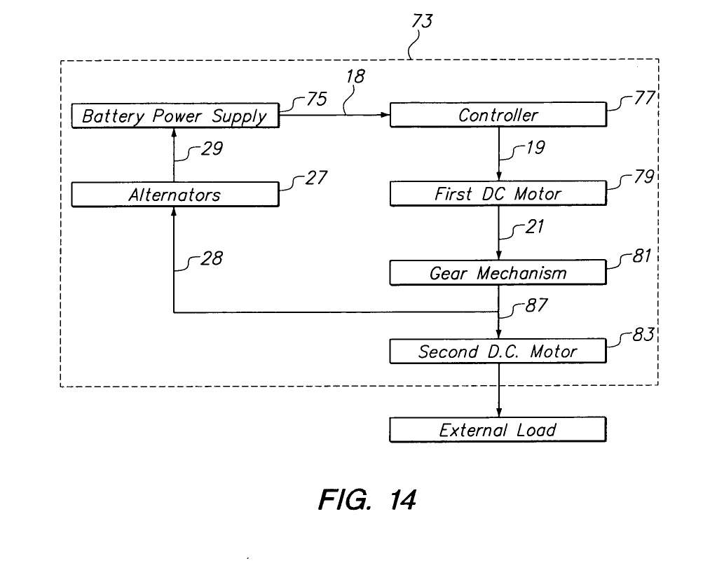

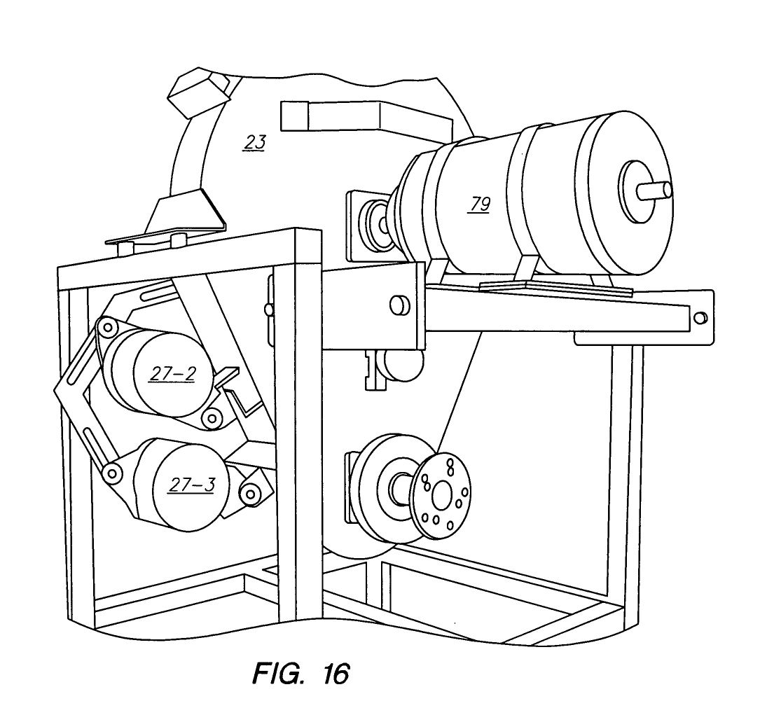

Referring now to FIGS. 14 through 16 and first to FIG. 14, there is shown a block diagram of another embodiment of a self generating electrical system according to this invention and identified by reference numeral D73.

Self generating system 73 includes a battery power supply 75, a controller 77, a first DC motor 79 and a gear mechanism 81 structurally and functionally identical to battery power supply 13, controller 17, first DC motor 15 and gear mechanism 23, respectively.

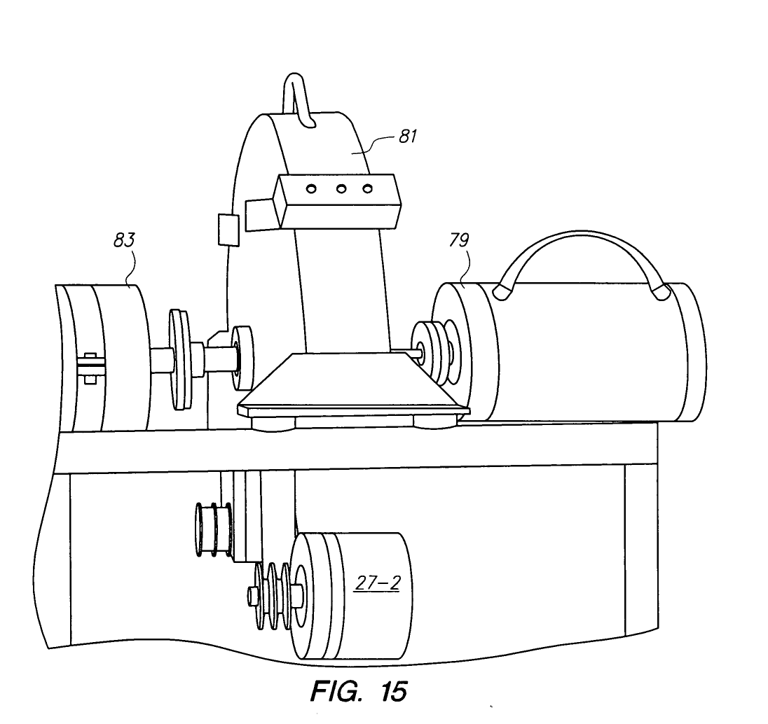

However, system 73 differs from system 11 in that it includes in addition a second DC motor 83. Second DC motor 83 is connected to the output end of shaft 87 of gear mechanism 81 and is arranged, as can be seen in FIG. 15, to function as an AC generator. Thus, the output of second DC motor has electrical energy rather than mechanical energy.

The discussion turns now to a fourth embodiment or third version of the is invention wherein the gear system is omitted. That is, the battery operated apparatus of the invention, without a gear box, can go make the prime mover, be it a forklift, or a truck go either forward or backward or be in neutral and stand still. The apparatus utilized for this 4^{th} embodiment is the same as the first and second embodiments, but minus the gearing system discussed supra.

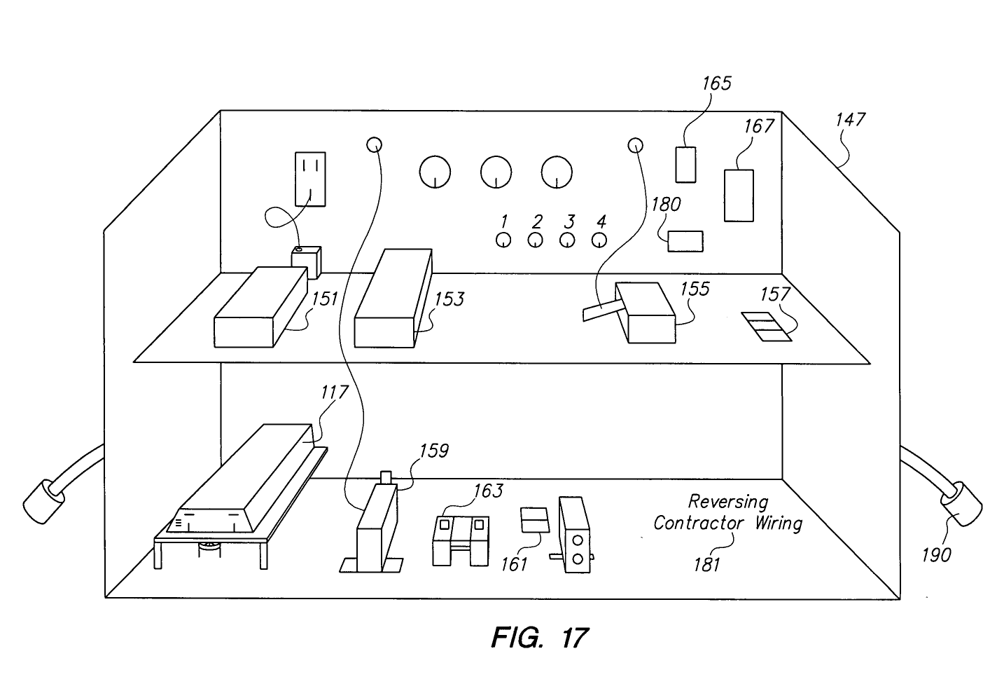

Thus reference is first made to FIG. 17, wherein the numbering system is in the 100 series, and like numbers refer to like parts as seen in FIG. 10, but in the 100 series. Therefore elements 117, 147 151, 153, 155, 159, 161, 163 and 190 need not be described again, as these have been discussed previously. Also seen in this figure is a main motor disconnect switch, 180 not found in the previous embodiments, as found labeled FIG. 10. Seen in the lower right corner of FIG. 17 is an open area of controller 147 simply lettered Reversing Contactor Wiring 181.

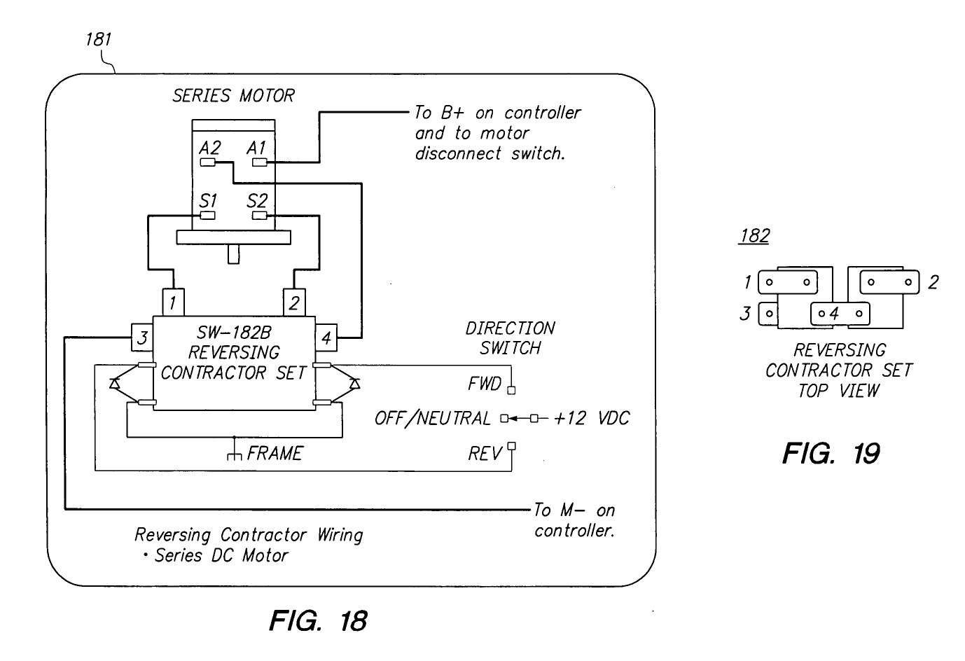

Reference should now be FIG. 18, which is a circuit diagram for the Revering Contactor wiring. Also found on this page is a top plan view of the contactor set 182 featured in the circuit diagram of FIG. 17.

The modified controller box of FIG. 17 was installed in a late 1990s Nissan pickup truck cab, from which the motor had been removed. The balance of the apparatus of this invention was installed along with an auxiliary 11 horsepower one cylinder engine, such as a Honda GX series engine under the hood. This small engine with 11 horsepower was used to aid the GMC truck to negotiate hills. This installation can be seen in FIG. 19. This FIGURE is a diagrammatic photo showing the installation of the instant apparatus without a gear box in the Nissan pickup. For the ease and convenience of the reader the parts have been labeled 191 through 198 with a table set forth in the figure of the parts represented by the particular designator, all of which are conventional.

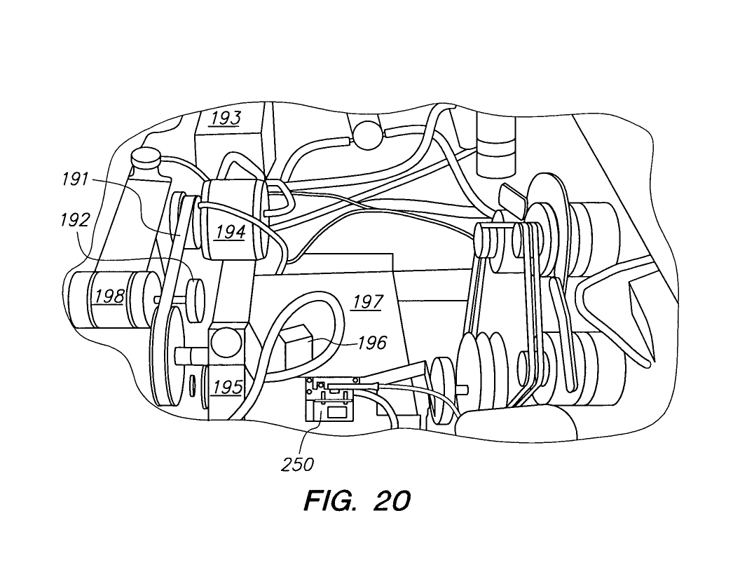

When the instant invention, 4^{th} embodiment, was installed, under the hood of the truck, it was found that the truck was capable of achieving speeds up to 50 mph on flat land in the forward position. The Honda GX engine, permitted the truck to climb normal landscape hills at a reasonable speed, such that the truck could substantially keep up with traffic. When the system was created, the normally available car/truck battery was used only to operate the lights, radio, turn signals, and other electrical components of the truck. The series of batteries that form the backbone of this invention were mounted beneath the truck cab, while the balance of the apparatus was mounted as shown in FIG. 20 under the hood.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A self generating electrical system comprising:
(a) a power supply for producing electrical energy, the power supply comprising a plurality of rechargeable batteries,
(b) a first DC motor for converting electrical energy to mechanical energy,
(c) a controller electrically coupled between the power supply and the first DC motor for receiving electrical energy from the power supply and supplying electrical energy to said first DC motor in a controlled manner,
(d) a plurality of DC alternators electrically coupled to the power supply for continuously recharging the batteries in the power supply, and
(e) a gear mechanism mechanically coupled to the first DC motor for selectively changing the energy output produced by the first DC motor, the output of the gear mechanism adapted to be connected to an external load and also to the plurality of DC alternators.

2. The self generating electrical system of claim 1 wherein the output of the power supply is 96 volts DC.

3. The self generating electrical system of claim 2 wherein the power supply is made up of eight 12 volt rechargeable batteries connected in series.

4. The self generating electrical system of claim 3 wherein the controller is 96 to 144 volts and 500 amps.

5. The self generating electrical system of claim 4 wherein the first DC motor is a 28 HP, 72 volt DC motor.

6. The self generating electrical system of claim 5 wherein the plurality of alternators comprises four alternators of 24 volts each all connected together in series.

7. The self generating electrical system of claim 6 wherein each alternator is 24 volts and 70 amps providing a total output of 96 volts and 280 amps.

8. A self generating electrical system comprising:
(a) a power supply for producing electrical energy, the power supply comprising a plurality of rechargeable batteries,
(b) a first DC motor for converting electrical energy to mechanical energy,
(c) a controller electrically coupled between the battery power supply and the first DC motor for receiving electrical energy from the battery power supply and supplying electrical energy to said first DC motor in a controlled manner,
(d) a plurality of DC alternators electrically coupled to the power supply for continuously recharging the batteries in the power supply, and
(e) a AC generator adapted to supply AC power to an external load,
(f) the AC generator and the plurality of alternators both being powered by said DC motor.

9. The self generating electrical system of claim 8 wherein the output of the power supply is 96 volts DC.

10. The self generating electrical system of claim 9 wherein the power supply is made up of eight 12 volt batteries connected in series.

11. The self generating electrical system of claim 10 wherein the controller is 96 to 144 volts and 500 amps.

12. The self generating electrical system of claim 11 wherein the DC motor is a 28 HP, 72 volt DC motor.

13. The self generating electrical system of claim 12 wherein the plurality of alternators comprises four alternators of 24 volts each all connected together in series.

14. The self generating electrical system of claim 13 wherein each alternator is 24 volts and 70 amps providing a total output of 96 volts and 280 amps.

15. Apparatus comprising:
(a) a self generating electrical system having a mechanical output, and
(b) an external load coupled to said mechanical output.

16. The apparatus of claim 15 wherein said external load comprises an automotive vehicle.

17. The apparatus of claim 15 wherein said external load comprises a water pump turbine system.

18. The apparatus of claim 15 wherein said external load comprises a compressor in an air conditioner.

19. Apparatus comprising:
(a) a self generating electrical system having an electrical output, and
(b) an external load coupled to said electrical output.

20. The apparatus of claim 19 wherein said external load is a house.

21. The apparatus of claim 19 wherein said external load is a commercial complex.

22. The apparatus of claim 19 wherein said external load is a piece of industrial machinery.

23. A self generating electrical system comprising:
(a) a power supply for producing electrical energy, the power supply comprising a plurality of rechargeable batteries,
(b) a first DC motor for converting electrical energy to mechanical energy,
(c) a controller electrically coupled between the power supply and the first DC motor for receiving electrical energy from the power supply and supplying electrical energy to said first DC motor in a controlled manner,
(d) a plurality of DC alternators electrically coupled to the power supply for continuously recharging the batteries in the power supply, and
(e) a second DC motor,
(f) a gear mechanism mechanically coupled to the first DC motor for selectively changing the energy output produced by the first DC motor and to the second DC motor, the output of the gear mechanism being connected to the second DC motor which is adapted to be connected to an external load and also to the plurality of DC alternators.

24. The second generating electrical system of claim 23 wherein the second DC motor is arranged to operate as an AC generator.

25. A self generating electrical system comprising:
(a) a power supply for producing electrical energy, the power supply comprising a plurality of rechargeable batteries,
(b) a first DC motor for converting electrical energy to mechanical energy,
(c) a controller electrically coupled between the power supply and the first DC motor for receiving electrical energy from the power supply and supplying electrical energy to said first DC motor in a controlled manner,
(d) a plurality of DC alternators electrically coupled to the power supply for continuously recharging the batteries in the power supply, and wherein the element (e)
(e) a gear mechanism mechanically coupled to the first DC motor for selectively changing the energy output produced by the first DC motor, the output of the gear mechanism adapted to be connected to an external load and also to the plurality of DC alternators is replaced by a reversing contactor system which permits the first DC motor to go either forward or backward or stay in a neutral position.

26. The self generating electrical system of claim 25 installed in a vehicle and further including an auxilliary small electrical motor to aid in hill climbing.
